(19) United States
(12) Patent Application Publication
(10) Pub. No.: US 2025/0387731 A1
(43) Pub. Date: Dec. 25, 2025

(54) METHOD AND DEVICE FOR CONTROLLING CHEMICAL DEMULSIFICATION IN FLOW

(71) Applicants: PETROLEO BRASILEIRO S.A. - PETROBRAS, Rio de Janeiro (BR); UNIVERSIDADE ESTADUAL DE CAMPINAS - UNICAMP, Campinas (BR)

(72) Inventors: Luiz Octavio Vieira Pereira, Rio de Janeiro (BR); Diane Otilia Lima Fontes, Campinas (BR); Flavio Vasconcelos Da Silva, Campinas (BR); Samuel Vitor Saraiva, Campinas (BR); Ana Maria Frattini Fileti, Campina (BR)

(21) Appl. No.: 19/231,998

(22) Filed: Jun. 9, 2025

(30) Foreign Application Priority Data
Jun. 20, 2024 (BR) BR 1020240125932

(51) Int. Cl. B01D 17/04

(52) U.S. Cl. CPC B01D 17/04

(57) ABSTRACT

The present invention relates to a method for controlling chemical demulsification in flow comprising: generating a sound pulse (Aₚᵤₗₛₑᵣ); receiving a modified sound pulse (A_{receiver}); processing the modified sound pulse (A_{receiver}), generating inputs for a controller; and controlling, by means of a controller, the parameters related to the emission of demulsifier. In addition, the invention also comprises a device for controlling chemical demulsification in flow.

### FIELD OF THE INVENTION

The present invention is part of the technical field of oil and gas production and transportation, especially in offshore exploration operations.

More specifically, the invention applies to the control of chemical demulsification in fluid flow systems, where the presence of emulsions can cause significant flow and processing problems.

### BACKGROUNDS OF THE INVENTION

In oil exploration, especially in mature wells, emulsions are formed in the pipes, which generate challenges in primary processing. These emulsions originate from the mixture of produced water and oil and are aggravated by the presence of natural surfactants in the oil. This water usually has a natural origin in the reservoir, but its production can be increased due to the injection of water to maintain the reservoir pressure.

The resulting emulsion has a much higher viscosity than pure oil, which poses a challenge for flow. In this case, the method commonly used to mitigate this phenomenon is to add a large amount of chemical demulsifier to the subsea pipes. This demulsifier destabilizes the emulsion, leading to the formation of segregated flow and considerably reducing the viscosity of the flowing fluid.

In this sense, the demulsifier assists in primary processing in order to guarantee the export of specified oil with up to 1% water. However, this type of substance presents a high logistical and acquisition cost for oil platforms.

Additionally, during flow, the demulsifier is dosed to ensure the breakup of the emulsion formed and, consequently, the reduction of viscosity. This dosage is done directly in the oil flow line through metering pumps. The dosing point depends on the field's operating conditions and can be injected from the wellhead to points upstream of the separators. Dosing is costly due to the price of the demulsifier, and most of these chemicals are industrial secrets. In this context, there is an effort to minimize the amount of dosed demulsifier, either to reduce costs or to ensure the optimum efficiency point. This effort translates into control strategies in the chemical demulsification process. However, this control is a challenge because it is difficult to find an efficient method to monitor the separation of the phases in the production pipeline. In practice, an injection flow rate is currently defined that remains fixed regardless of the process conditions (open loop).

In short, the injection flow rate of this product is defined at a specific value and is not controlled in a closed loop by means of a process parameter. This can lead to two consequences: unnecessarily high injection of demulsifier, often generating high costs and/or loss of separation efficiency; or low product injection, which can lead to a loss of phase separation efficiency.

In this way, the technical problem solved by the present invention consists of providing control of the chemical demulsification with the smallest amount of demulsifier, aiming at a gain in economic and environmental terms, due to the costs associated with the use and acquisition of the chemical product, as well as its aggressiveness to the environment.

### STATE OF THE ART

Document WO2021044317A1 presents an in-line demulsification system for separating emulsions in multiphase fluids using ultrasonic waves. The proposed system operates as follows: an in-line flow conditioner separates the multiphase fluid into its constituent parts, generally a liquid phase and a gaseous phase, wherein the liquid phase contains an emulsion, which is the target of the separation; an ultrasonic wave device, located downstream of the flow conditioner, emits ultrasonic waves toward the multiphase fluid. These waves are directed at the emulsion within the liquid phase. The energy from the ultrasonic waves helps break the emulsion into its individual components, facilitating the separation process. Depending on the system configuration, additional components such as sensors and a processor/controller may be included. These components measure various properties of the multiphase fluid and adjust parameters of the ultrasonic wave emission as needed.

Document US2023089200A1 presents a device and a process for separating and analyzing a multiphase fluid, specifically for separating and analyzing the aqueous liquid phase of a multiphase fluid produced from a hydrocarbon formation. The device includes a separation chamber with an inlet for the multiphase fluid and an outlet for the aqueous liquid phase. In addition, the device includes a demulsifier source for introducing demulsifier into the separation chamber, and a fresh water source for diluting the aqueous liquid phase sample. The water analysis unit includes an analytical cell with probes that measure properties of the diluted sample. A processor receives the diluted sample data and calculates approximate aqueous liquid phase data, taking into account the amount of fresh water used to dilute the sample. This device and process allow for the automated continuous analysis of discrete multiphase fluid samples, providing reliable and timely data to calibrate, optimize, and control a multiphase flow meter. However, unlike the present invention, document US2023089200A1 fails to describe any type of strategy to define parameters associated with the introduction of the demulsifier in response to changes in variables inherent to the demulsification process.

Document CN113486579A1 presents a method, device, and system for predicting oil and water separation based on the microscopic distribution of droplets. The method integrates mechanism models and artificial intelligence algorithms to accurately predict the efficiency of oil and water separation in a three-phase separator. This is achieved through several steps, including obtaining structural parameters of the separator, determining the lifetime of the emulsified liquid film, establishing droplet diameter evolution models, and modeling the separation efficiency. The device involves processing units for executing the steps of the method, while a computer storage medium and a computer device are also provided for implementing the method. This invention aims at improving the efficiency and accuracy in the separation of oil and water in industrial operations. However, it is clear that this document focuses on improvements in the process of separating phases of the mixture, whereas the present invention focuses on defining the dosage of demulsifier in production lines by means of parameters relating to data obtained by stimulating a section of the line by means of ultrasound.

Document WO2021011370A presents a multiphase liquid separation control system, a separator and an associated method. The system includes an internal liquid mixture volume detector, a chemical treatment system and a controller that receives a signal from the internal volume detector and controls an operational parameter based on this signal. In this sense, the method involves detecting the volume of a multiphase liquid mixture within a liquid separator in operation, determining operational targets based on this volume and applying these targets to the separator. However, document WO2021011370A fails to describe the definition/control of demulsifier dosage in production lines by means of parameters related to data obtained by stimulating a section of the line by means of ultrasound.

Document U.S. Ser. No. 11/008,521B1 presents methods for determining a precise dosage of demulsifier to remove a specific amount of water from a hydrocarbon stream processed in a series of one or more phase separator vessels in a train of separators in an oil and gas separation station. However, document U.S. Ser. No. 11/008,521B1, as well as other documents in the state of the art fail to describe the measurement of emulsification parameters by means of ultrasound.

Therefore, it is clear that the documents of the state of the art do not address to an external device (ultrasonic cell) to the fluid flow that interacts with the sample, with the aid of a pulser and transducer, to extract characteristics of the fluid and, thus, by means of a method that includes fuzzy logic, determine the variations in the injection flow rate of the demulsifier.

### SUMMARY OF THE INVENTION

The present invention proposes a method for controlling chemical demulsification in flow comprising: generating a sound pulse (Aₚᵤₗₛₑᵣ); receiving a modified sound pulse (A_{receiver}); processing the modified sound pulse (A_{receiver}), generating inputs for a controller; and controlling, by means of a controller, the parameters related to the injection of the demulsifier.

Furthermore, the invention also comprises a device for controlling chemical demulsification in flow.

### BRIEF DESCRIPTION OF THE DRAWINGS

The present invention will be described below with reference to typical embodiments thereof and also with reference to the attached drawings, in which:

FIG. 1 is a representation of the device of the present invention.

FIG. 2 is a representation of the internal structures of the central part of the device according to the present invention.

FIG. 3 presents the flowchart of the method according to the present invention.

FIG. 4A is a representation of the signals with digitized echoes of a homogeneous emulsion without addition of demulsifier according to an embodiment of the present invention.

FIG. 4B is a representation of the signals with digitized echoes of a segregated emulsion with addition of demulsifier according to an embodiment of the present invention.

FIG. 5 illustrates the representation of the classification of the 4 flow regimes developed during the chemical demulsification in the flow according to an embodiment of the present invention.

FIG. 6 illustrates a block of the fuzzy control implemented to act on the dosage (flow rate) of demulsifier according to an embodiment of the present invention.

FIG. 7 illustrates a diagram of the flow circuit according to an embodiment of the present invention.

FIG. 8 illustrates a classification of the ultrasonic variables during the monitoring of the chemical demulsification according to an embodiment of the present invention.

FIG. 9 illustrates pertinence functions of the fuzzy control output according to an embodiment of the present invention.

FIG. 10 illustrates pertinence functions of the fuzzy control inputs according to an embodiment of the present invention.

FIG. 11 illustrates the monitoring of the open circuit variables during the actuation of the fuzzy control in the demulsification of the flow according to an embodiment of the present invention.

### DETAILED DESCRIPTION OF THE INVENTION

The present invention is intrinsically related to improvements in the use of the demulsifier on demand. Thus, the use of a device that aims at maintaining the flow in an established regime (segregated) is proposed. Furthermore, as it is non-intrusive, the device facilitates installation and ensures additional safety for the flow.

In this way, the main objective is to ensure that the fluid flowing in the pipeline is segregated, significantly reducing the energy demand, in order to guarantee the flow. In addition, the device is associated with a method to minimize the amount of dosed demulsifier to destabilize the emulsion, representing a gain in economic and environmental terms.

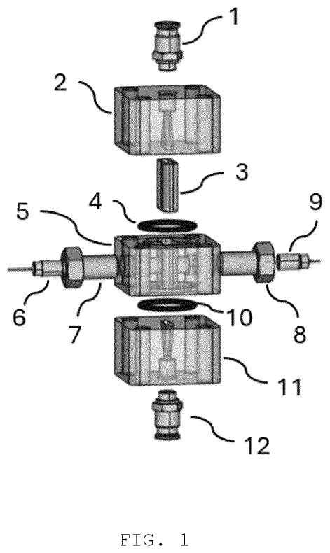

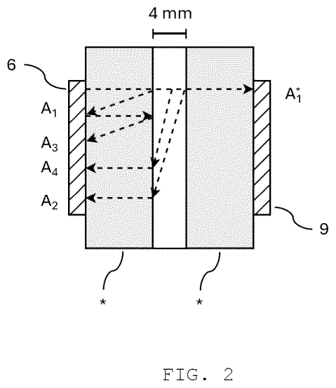

The device was manufactured in acrylic and is subdivided into three larger parts 2, 5 and 11, as shown in FIG. 1. The upper part 2 and lower part 11 are identical, having the coupling for the flow inlet and outlet (sample). At the flow inlet and outlet there are quick-connect fittings 1 and 12, in addition to the gap that houses the sealing rings 4 and 10 with the central part 5. The central part 5 has chambers that house the ultrasonic transducers 6 and 9. The transducers are fixed with machined screws 7 and 8 to couple the transducers and their electrical cables. The central part 5 is detailed in FIG. 2, having a 4 mm thick chamber through which the sample passes and the walls indicated by * between the transducers 6 and 9 and the sample chamber 5 (delay line). The central chamber was designed to avoid the formation of preferential paths in the cell.

The cell design, related to the choice of material and the length of the delay and sample lines, was developed based on simulations of a physical model of sound wave propagation in the medium. It is important to note that acrylic, despite having high attenuation, has a high transmission coefficient when compared to other materials such as steel or aluminum. Therefore, it is possible to obtain the signal echo in the receiving transducer with greater amplitude.

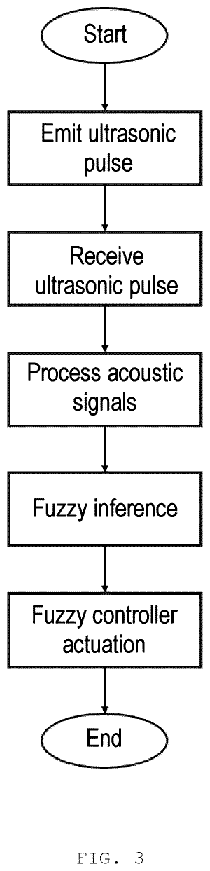

In this device, a pulser excites the transducer, which sends a sound pulse to its pair. The transducer that is excited is called the emitter, and the one that receives the signal, the receiver. The signal emitted by the emitter (Aₚᵤₗₛₑᵣ) propagates in the mechanical apparatus of the cell and sample until it reaches the receiver (A_{receiver}), as presented in FIG. 2. More specifically, it is worth highlighting that the method proposed by the present invention is divided into two steps: acoustic signal processing; and fuzzy control. The flowchart of the method is presented in FIG. 3.

### Acoustic Signal Processing

The sound signal obtained by the digitalization system is processed to extract the acoustic variables: sound attenuation (α), reflection coefficient (R₁₂), and speed of sound (c), through equations (1), (2) and (3), respectively:

$$α = {α}^{′} + \frac{1}{l} ln \{ \frac{( 1 - {( {A}_{1} / {A}_{1}^{air} )}^{2} ) {A}_{1}^{* ′}}{( 1 - {( {A}_{1}^{′} / {A}_{1}^{air} )}^{2} ) {A}_{1}^{*}} \} ; \qquad ( 1 )$$

$${R}_{12} = - \frac{{A}_{1}}{{A}_{1}^{air}} ; \qquad ( 2 )$$

$$c = \frac{2 l}{{τ}_{cross}} , \qquad ( 3 )$$

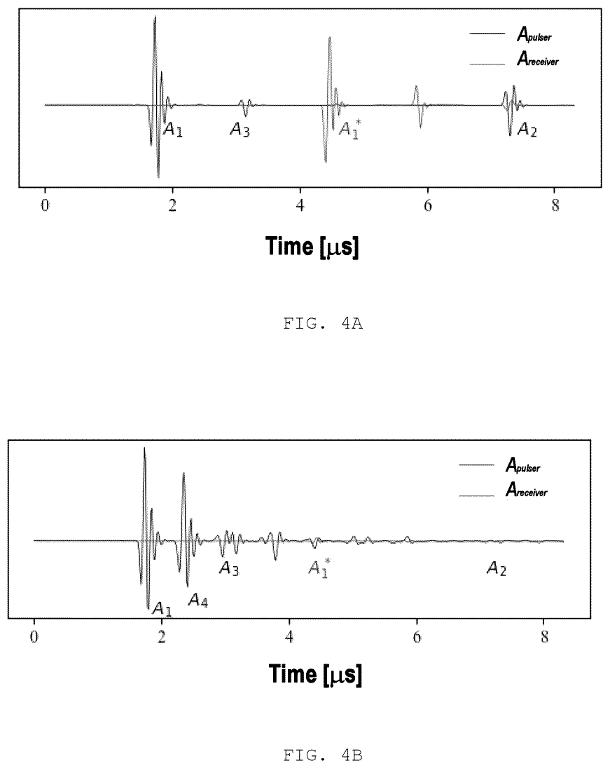

α′ is the attenuation of a reference sample. Water can be used as a reference sample, whose acoustic properties are documented. A₁^{air} represents the first echo when the cell is filled with air. A₁′* represents the first echo from the receiving transducer when the sample used is the reference. τ_{corr} represents the cross-correlation time between echoes A₁ and A₂, shown in FIG. 4A. The sample propagation path is calculated using the speed of sound of the reference sample and the cross-correlation time through equation (3).

The variable relative amplitude of the echo (K) was defined by dividing the maximum amplitudes of echo A₄ and echo A₁ at the frequency, shown in FIG. 4B. Echo A₄ appears only when there is phase segregation caused by demulsification. The signal is reflected in the sample, between the interfaces of the segregated phases.

The relative amplitude is calculated by equation (4). In the equation, FFT represents the Fourier transform of the echo. This function is valid for a frequency higher than 2 MHz, so that this frequency filter eliminates the effect of possible noise in the sample zone, ensuring that only echoes are considered.

$$K = \{ \begin{matrix}\frac{max ( FFT ( {A}_{4} )}{max ( FFT ( {A}_{1} )} , & F \geq 2 MHz \\ 0 , & F < 2 MHz\end{matrix} ,$$

The acoustic variables were monitored during the chemical demulsification. Patterns of changes in these variables were observed according to the flow regime in the demulsification process. The most significant changes were in the increase in the dispersion of these acoustic variables during the demulsification. This dispersion was calculated through the standard deviation of the variables monitored over time. Equation (5) presents the calculation of the standard deviation of the speed of sound (c) [m/s], the reflection coefficient (R₁₂), the acoustic attenuation (α) [np/m] and the relative amplitude of the echo in the sample (K). The dispersion of these variables were the first inputs to the fuzzy controller.

$${σ}_{x} = \sqrt{{\sum }_{i = 1}^{n} {\vert {x}_{i} - \overline{x} \vert}^{2} / n} , \qquad ( 5 )$$

The constant n refers to the number of samples (length of the time series), to which the standard deviation calculation is applied. In this way, in monitoring, the calculated standard deviation refers to the 60 data prior to the current time. The number of samples is also used in the calculation of the moving average.

With the relative amplitude data of the echo in the sample, it was possible to calculate the frequency of echoes in the sample through equation (6). This frequency translates into the number of echoes in n times. In this case, n represents 60 samples. This sum considers the appearance or not of echoes in the sample with the values 1 and 0, respectively.

$${f}_{K} = \frac{1}{n} {\sum }_{i = 0}^{n} {k}_{n} \{ \begin{matrix}{k}_{n} = 1 , & K > 0 \\ {k}_{n} = 0 , & K = 0\end{matrix} , \qquad ( 6 )$$

The last acoustic variable used as input in the control system was the relative speed. The relative speed basically calculates how far the average speed of the emulsion is from the speed of the oil phase (cₒ) and water (cₐ), under the same temperature conditions (T). This relative speed was calculated using equation (7). Using this variable, it was possible to attenuate the effect of temperature in the control system. The speed of sound in the emulsion is temperature dependent, so the calculation of the relative speed becomes more comprehensive, being able to characterize and standardize the flow at different temperatures. In equation (8), c̅ represents the moving average of the speed of sound in the emulsion given by equation (3):

$${c}_{rl} = \frac{{c}_{a} ( T ) - \overline{c}}{{c}_{o} ( T ) - {c}_{a} ( T )} ; \qquad ( 7 )$$

$$\overline{c} = \frac{1}{n} {\sum }_{i = 0}^{n} c [ i ] , \qquad ( 8 )$$

### Fuzzy Control

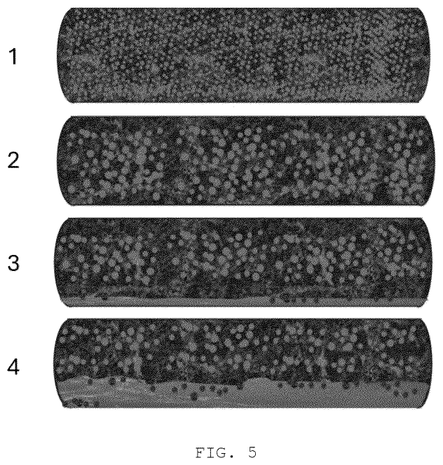

The fuzzy control step aims at determining the appropriate amount of demulsifier to be injected, identifying the flow regime of the emulsion through ultrasonic variables. The purpose of the fuzzy controller, in this context, is to maintain the flow in a specific regime (controlling demulsification). The classification of four regimes was based on flow monitoring, as illustrated in FIG. 5, with each regime indicated by the corresponding number.

Regime 1: The flow exhibits a homogeneous appearance with a white coloration. In this regime, although there is a change in the viscosity of the emulsion with the addition of the demulsifier and an increase in the average size of the droplets, it is not possible to observe the movement of the flow. Due to these characteristics, this regime was designated as stable homogeneous flow, as it resembles the flow without the presence of the demulsifier.

Regime 2: The flow continues with a homogeneous appearance; however, there is a change in the color of the emulsion. The emulsion acquires a yellowish hue, as a result of its instability caused by the increase in the size of the droplets. The oily phase becomes more evident and there is better passage of light through the sample. This regime is very close to phase segregation, which is why it was called unstable homogeneous flow.

Regime 3: In this regime, phase segregation occurs due to the increase in the amount of demulsifier. This formation of phases is slightly noticeable in the flow. The aqueous phase flows in small filaments close to the pipeline wall. This regime was called segregated flow.

Regime 4: The flow has characteristics similar to regime 3. However, due to the increase in the concentration of the demulsifier, a more intense phase segregation occurs. As the flow is laminar at low speed, the segregated aqueous phase flows in the regions close to the pipeline wall at a higher speed than the oil phase. These differences in the flow speed of the phases occur due to the lower viscosity of water in relation to oil. The friction caused by the oil phase with the pipeline wall is greater than that caused by the aqueous phase, so the aqueous phase flows with greater ease and speed. Due to these characteristics, this regime was called phase slippage.

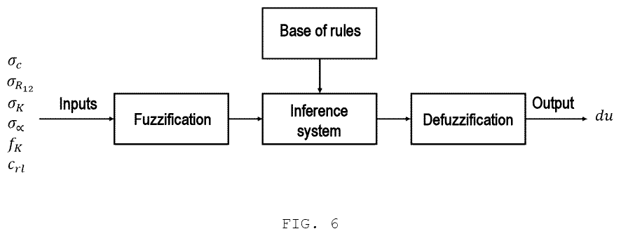

The fuzzy controller is based on expert knowledge about the process, in this case, in-line demulsification. The fuzzy controller has a sequence of calculations divided into 3 steps: fuzzification, fuzzy inference and defuzzification. These steps are described in the list below and the representation of the fuzzy control is presented in FIG. 6.

Fuzzification: In this layer, each node computes the degree of pertinence of the input variables according to the fuzzy sets defined and linked to the linguistic terms of each variable. For variables 2, 3, 4 and 6, there are two linguistic terms that define them: low and high. For variables 1 and 5, the associated linguistic terms are low, medium and high. In this system, triangular and trapezoidal functions were used, represented by equations (9) and (10):

$$μ {A}_{i} ( x ) = \{ \begin{matrix}0 , & x \leq a \\ \frac{x - a}{c - a} , & a < x \leq b \\ \frac{c - x}{c - b} , & b \leq x < c \\ 0 , & x \geq c\end{matrix} ; \qquad ( 9 )$$

$$μ {A}_{i} ( x ) = \{ \begin{matrix}0 , & x \leq a \\ \frac{x - a}{c - a} , & a < x \geq b \\ 1 , & b \leq x \leq c \\ \frac{c - x}{c - b} , & b \leq x < c \\ 0 , & x \geq c\end{matrix} . \qquad ( 10 )$$

Mandani inference system: With the pertinence functions that define the qualifying terms of the linguistic variables in relation to the system's input data, it was possible to proceed with the definition of a set of rules. The rules present a set of conditions that make use of logical operators “and” and “or” expressed mathematically by equations (12) and (13), respectively:

$${r}_{k} = μ {A}_{i} ( x ) ⋂ μ {A}_{j} ( x ) ; \qquad ( 12 )$$

$${r}_{k} = μ {A}_{i} ( x ) ⋃ μ {A}_{j} ( x ) . \qquad ( 13 )$$

Defuzzification: With the implication value of each rule, defuzzification is applied. In this case, the centroid defuzzification method described in Equation (14) was used:

$${du}^{*} = \frac{\int {μ}_{C} ( {r}_{i} ) {r}_{i} dr}{\int {μ}_{C} ( {r}_{i} ) dr} , \qquad ( 14 )$$

After calculating the centroid, du* is denormalized to return the value of the variable on the standard scale. The limits {dumin, dumax} represent the maximum and minimum variation of the manipulated variable, taking into account the process actuator limit.

### Application Example

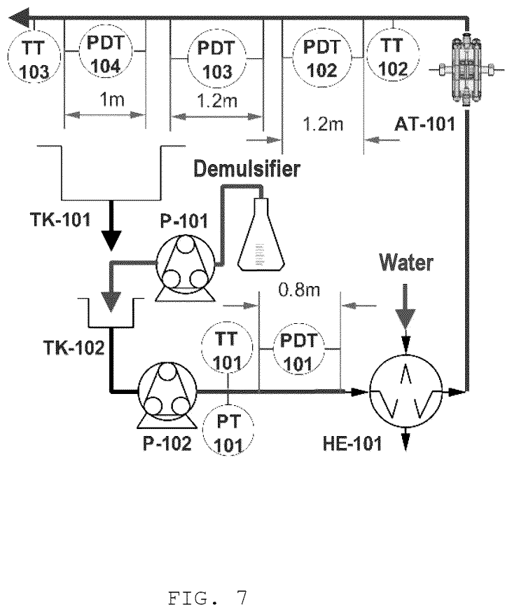

The developed control was applied to a flow plant, with an open circuit. The circuit was built with 9 meters of ½-inch (1.27 cm) stainless steel piping thermally insulated with foam rubber lining, as shown in FIG. 7. The prepared emulsion was stored in the circuit's 25 L stainless steel tank (TK-101).

The circuit was instrumented by a series of differential pressure transducers (PDT101 to PDT104) that were used to characterize the viscosity of the emulsion throughout the process. The temperature transducers (TT101 to TT103) assisted in calculating the viscosity. The absolute pressure transducer (PT101) was used to check the pressure in the system and help maintain its safety.

In addition to thermal insulation, the heat exchanger (HE-101) was used to ensure the stability of the system temperature. A thermostatic bath was used in the exchanger, which pumped water at a fixed temperature to the single-pass shell and tube heat exchanger.

After the sample was stored, a pump P-102 was activated. When the circuit reached steady state and all monitored variables stabilized, the experiment was initiated. The emulsion was discarded after being circulated through all the components of the circuit.

Pump P-101 was installed to dose the demulsifier in the line. The demulsifier is stored in a graduated reagent bottle and is dosed at the suction point of pump P-102, located at the outlet at the bottom of the tank. The volumetric flow rate of the dosed demulsifier is calculated using Equation (15):

$${q}_{D} = {Qc}_{Q} / ( {c}_{D} - {c}_{Q} ) , \qquad ( 15 )$$

where Q and q_{D} represent the volumetric flow rates of the emulsion and demulsifier, respectively. c_{Q} is the desired concentration of demulsifier to be achieved in the flow, and c_{D} is the dilution of the demulsifier in absolute alcohol, which was stored. The analysis transducer (AT-101) refers to the installed ultrasonic sensor.

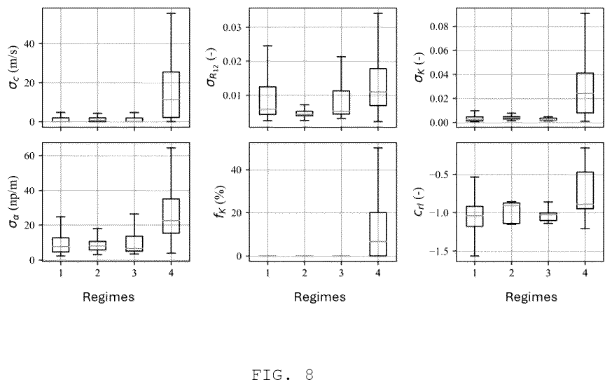

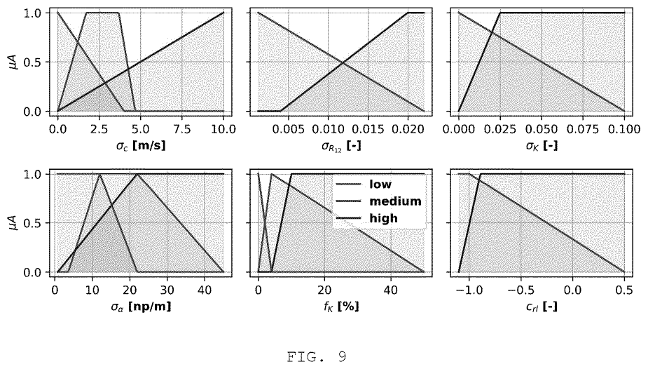

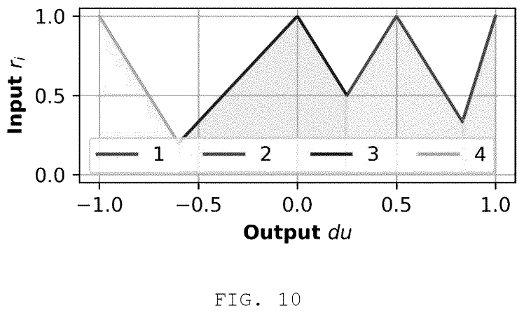

For fuzzy control, six input acoustic variables were selected, and their pertinence functions initially needed to be defined. Taking these acoustic variables as linguistic variables, qualifying terms were defined for each of them. Each of these terms was defined by a pertinence function. The parameters that define these functions were obtained through analysis of the dispersion and average of the variables in different regimes. FIG. 8 presents the statistical analysis for the acoustic variables. For example, it can be seen from the data dispersion that OK can be divided into two groups. The first group, encompassing regimes 1, 2 and 3, with data dispersed between 0 and 0.01 and some points outside the distribution reaching 0.1. And the second group encompassing regime 4 with distribution between 0 and 0.43 and average at 0.025, as can be seen in FIG. 8. Therefore, two pertinence functions were assigned to this variable that define the terms low and high. FIG. 9 presents the pertinence functions for each input variable of the system. Next, the set of rules implemented in the system was constructed, presented in Table 1. The final calculation of the fuzzy controller action is illustrated in FIG. 10. The maximum and minimum variation of the flow rate (demulsifier dosage) was considered to be −2 to 2 ml/min.

TABLE 1
Rules of the fuzzy control system.

| σ_{c} | | σ_{R}_{₁₂} | | σₐ | | σ_{K} | | f_{K} | | cᵣₗ | | Regime |
|---|---|---|---|---|---|---|---|---|---|---|---|---|
| low | AND | low | AND | low | AND | low | AND | low | AND | low | THEN | 1 |
| low | | | | | | | | low | | low | | 1 |
| low | | low | | low | | low | | medium | | low | | 2 |
| medium | | low | | high | | high | | high | | high | | 3 |
| high | | high | | high | | high | | high | | high | | 4 |
| high | | | | | | | | | | high | | 4 |

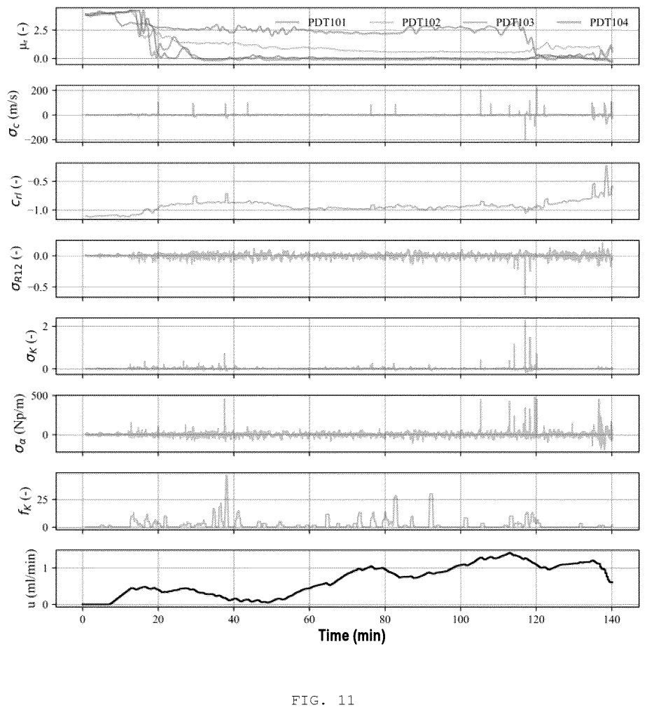

FIG. 11 presents the monitoring of the circuit variables during the action of the fuzzy controller initialized at 7 min. FIG. 11 shows that, initially, the fuzzy system identified the flow as a homogeneous regime (regime 1), activating the actuator until it reached 0.47 ml/min. After that, the flow rate oscillates slightly around this value. This indicates that during this period the controller identified a phase segregation. The significant drop in viscosity during this period indicates that the flow segregated.

At 30 min, the demulsifier flow rate decreases to a value of around 0.1 ml/min, at time 45 min. This indicates that the controller identified a phase slippage regime and acted by reducing the amount of the dosed demulsifier.

At 46 min, a disturbance was introduced into the process. This disturbance was the decrease in the flow temperature from 40 to 30° C. Due to this decrease, the viscosity of the emulsion increases and there is a need for a greater amount of demulsifier to break the emulsion. This need was identified by the controller, which increased the demulsifier flow rate to 1 ml/min at 80 min.

The next disturbance occurred with the change in the water content of the emulsion from 40% w/w to 50% w/w. It was observed that there was a tendency for the demulsifier flow rate to increase to a point close to 1.4 ml/min at 113 min; however, this change did not occur due to the disturbance caused by the sample change. When observing the relative viscosity, the presence of the emulsion with a higher water content was only perceived by the controller at 115 min. The higher the water fraction, the lower the amount of demulsifier needed to promote the phase segregation. This lower need for demulsifier was perceived by the control, which reduced the amount dosed in the system to 1 ml/min at 120 min.

The last disturbance occurred at 124 min with an increase in temperature to 40° C. This increase in temperature was only perceived by the fuzzy controller at 135 min, which classified the flow as a phase slippage regime, initiating a sudden decrease in the flow rate of dosed demulsifier.

1. A method for controlling chemical demulsification in flow, comprising the steps of:
i. generating a sound pulse (Aₚᵤₗₛₑᵣ);
ii. receiving a modified sound pulse (A_{receiver});
iii. processing the modified sound pulse (Aₚᵤₗₛₑᵣ), generating inputs to a controller; and
iv. controlling, by means of the controller, parameters related to the injection of demulsifier.

2. The method according to claim 1, wherein step (i) comprises exciting a transducer by means of a pulser.

3. The method according to claim 1, wherein the sound pulse (Aₚᵤₗₛₑᵣ) is modified by interaction with a flow medium.

4. The method according to claim 1, wherein step (iii) comprises:
extracting acoustic variables from the modified sound pulse (A_{receiver});
calculating standard deviation of the acoustic variables;
calculating standard deviation of a relative amplitude (K) between sound echo (A₄) and sound echo (A₁);
calculating frequency of echoes in a sample (f_{K}); and
calculating relative speed (cᵣₗ).

5. The method according to claim 4, wherein the acoustic variables, sound attenuation (α), reflection coefficient (R₁₂), and speed of sound (c), are defined as:
$$α = α \qquad ( 1 )$$
$${R}_{12} = - \frac{{A}_{1}}{{A}_{1}^{air}} \qquad ( 2 )$$
$$c = \frac{2 l}{{τ}_{cross}} , \qquad ( 3 )$$
wherein α′ is an attenuation of a reference sample; A₁^{air} represents a first echo when a cell is filled with air; A₁′* represents a first echo from the receiving transducer when the sample used is the reference sample; τ_{corr} represents a cross-correlation time between echoes A₁ and A₂; and l is a propagation path of the sample.

6. The method according to claim 4, wherein the calculation of the relative amplitude (K) between the echo (A₄) and the echo (A₁) comprises:
$$K = \{ \begin{matrix}\frac{max ( FFT ( {A}_{4} )}{max ( FFT ( {A}_{1} )} , & F \geq 2 MHz \\ 0 , & F < 2 MHz\end{matrix} , \qquad ( 4 )$$
wherein FFT represents a Fourier transform of the echo; this function is valid for a frequency higher than 2 MHz, and this filter at the frequency eliminates the effect of possible noise in the sample zone, ensuring that only the echoes will be considered.

7. The method according to claim 4, wherein the calculation of the standard deviation of the acoustic variables comprises:
$${σ}_{x} = \sqrt{{\sum }_{i = 1}^{n} {\vert {x}_{i} - \overline{x} \vert}^{2} / n} , \qquad ( 5 )$$
wherein x refers to the acoustic variable; and n refers to a number of samples in a time series.

8. The method according to claim 4, wherein the calculation of the frequency of echoes in the sample (f_{K}) comprises:
$${f}_{K} = \frac{1}{n} {\sum }_{i = 0}^{n} {k}_{n} \{ \begin{matrix}{k}_{n} = 1 , & K > 0 \\ {k}_{n} = 0 , & K = 0\end{matrix} , \qquad ( 6 )$$
wherein a sum considers a appearance or not of echoes in the sample with values 1 and 0, respectively.

9. The method to claim 4, wherein the calculation of the relative speed (cᵣₗ) comprises:
$${c}_{rl} = \frac{{c}_{a} ( T ) - \overline{c}}{{c}_{o} ( T ) - {c}_{a} ( T )} ; \qquad ( 7 )$$
$$\overline{c} = \frac{1}{n} {\sum }_{i = 0}^{n} c [ i ] , \qquad ( 8 )$$
wherein c̅ is an average speed of an emulsion; cₒ(T) is a speed of an oily phase; and cₐ(T) is a speed of water, under the same conditions of temperature T.

10. The method to claim 1, wherein step (iv) comprises:
defining linguistic variables and their qualifying terms;
assigning pertinence functions to each qualifying term by defining parameters {a, b, c} or {a, b, c, d};
applying the definition of the fuzzy rules considering the Mamdani inference system; and
applying centroid method for defuzzification.

11. The method to claim 10, wherein triangular and trapezoidal pertinence functions are defined as:
$$μ {A}_{i} ( x ) = \{ \begin{matrix}0 , & x \leq a \\ \frac{x - a}{c - a} , & a < x \leq b \\ \frac{c - x}{c - b} , & b \leq x < c \\ 0 , & x \geq c\end{matrix} ; \qquad ( 9 )$$
$$μ {A}_{i} ( x ) = \{ \begin{matrix}0 , & x \leq a \\ \frac{x - a}{c - a} , & a < x \geq b \\ 1 , & b \leq x \leq c \\ \frac{c - x}{c - b} , & b \leq x < c \\ 0 , & x \geq c\end{matrix} . \qquad ( 10 )$$

12. The method to claim 10, wherein application of the set of rules comprises:
$${r}_{k} = μ {A}_{i} ( x ) ⋂ μ {A}_{j} ( x ) ; \qquad ( 12 )$$
$${r}_{k} = μ {A}_{i} ( x ) ⋃ μ {A}_{j} ( x ) . \qquad ( 13 )$$

13. The method to claim 12, wherein the defuzzification uses the centroid method to determine the result of the region found according to the equation below:
$${du}^{*} = \frac{\int {μ}_{C} ( {r}_{i} ) {r}_{i} dr}{\int {μ}_{C} ( {r}_{i} ) dr} , \qquad ( 14 )$$
wherein μ_{C} is area formed by grouping of the pertinence functions, and rᵢ corresponds to a respective input.

14. The method to claim 13, wherein du* is denormalized to return a value of the variable on a standard scale and dosage of demulsifier is applied.

15. A device for controlling chemical demulsification in flow comprising:
a housing;
an upper part with coupling for flow outlet;
a lower part with a coupling for flow inlet;
a central part;
wherein the upper part and lower part have a gap that houses their respective sealing rings with the central part, wherein the central part additionally comprises:
two chambers that house ultrasonic transducers; and
a sample passage chamber.

16. The device according to claim 15, wherein the housing of the device was manufactured in acrylic.

17. The device according to claim 15, wherein the sample passage chamber presents two acrylic walls between each of the transducers and the sample.
